(19) United States
(12) Patent Application Publication
(10) Pub. No.: US 2024/0054820 A1
(43) Pub. Date: Feb. 15, 2024

(54) METHODS AND SYSTEM FOR GEO-DIFFERENTIATED VIRTUAL TOLL BOOTH

(71) Applicant: Eagle Pass Technologies Corporation, Rockville, MD (US)

(72) Inventors: Roberto Bernades, West Friendship, MD (US); Jerry Godwin, Rockville, MD (US)

(21) Appl. No.: 17/766,493

(22) PCT Filed: Oct. 6, 2020
(86) PCT No.: PCT/US2020/054327

§ 371 Date: Apr. 4, 2022

Related U.S. Application Data
(60) Provisional application No. 62/912,292, filed on Oct. 8, 2019.

(51) Int. Cl. G07B 15/06; G06Q 20/32

(52) U.S. Cl. CPC G07B 15/063; G06Q 20/3224; G06Q 2240/00

(57) ABSTRACT

Methods and system for geo-differentiated virtual tool booth (GDVTB) supporting seamless toll collections across disparate toll systems are disclosed. The GDVTB system may leverage smart technology to identify a moving vehicle location. The GDVTB may also reconcile an identified vehicle location with a vehicle location captured by a toll operator or with multiple vehicle locations associated with multiple other GDVTBs. A common vehicle identifier, which may be associated with a user's smart device and may be captured by the toll operator, may support reconciliation of the identified and captured locations. The present invention may also include methods for real time, delayed, and pre-paid toll collections.

### CROSS-REFERENCE TO RELATED APPLICATION

This application claims the benefit of U.S. Provisional Application No. 62/912,292, filed on Oct. 8, 2019.

### BACKGROUND OF THE INVENTION

State governments have authority to toll motor vehicles to, for example, finance interstate construction and reconstruction and reduce traffic congestion. All electronic tolling (AET) has eliminated the need for toll booths by eliminating cash toll collection (and leakage) at the roadside. Current AET systems use electronic sensors to identify most vehicles through an on-board transponder. This is accomplished by a radio-frequency identification (RFID) emitting electromagnetic waves. Accordingly, transponder use may support collecting tolls to finance road infrastructure.

Some drivers continue to pay tolls in cash. A main obstacle to AET use is transponder costs for users that would rather pay cash or receive a notice in the mail about an infraction. Further, at least 14 toll operating systems collect tolls across the national road system, and each operator may employ a different transponder. The toll operators and local governments recognize the high costs associated with transponder interoperability and trying to make roadside equipment better. Accordingly, AET transponder costs and interoperability may impact toll collection.

### SUMMARY OF THE PRESENT INVENTION

Various exemplary embodiments of the present disclosure may demonstrate one or more of the invention features. Other features and advantages of this invention will become apparent from the following detailed description of the presently preferred embodiments of the invention, taken in conjunction with the accompanying drawings.

In accordance with an exemplary embodiment, a toll collection system includes a smart device associated with a user account. The toll collection system further includes the associated smart device and a toll operating system in communication via a geo-differentiated virtual toll booth. The toll collection system further includes a toll paid by the registered user account to the toll operating system via the geo-differentiated virtual toll booth.

In accordance with another exemplary embodiment, a method of collecting toll payments includes associating a smart device with a user account and tracking a location of the associated smart device. The method further includes identifying the associated smart device location as a virtual toll collection zone associated with toll fees and a toll operator system. The method further includes distributing the toll fees from the user account to the toll operator system.

In accordance with a further exemplary embodiment, a method of pre-paying toll fees includes associating a smart device with a vehicle identifier. The method further includes planning a trip route using the associated smart device and identifying at least one virtual toll collection zone along the trip route. The method further includes pre-paying a toll fee associated with the at least one virtual toll collection zone. The method further includes tracking a location of the smart device; and processing errors in toll fee pre-payments.

It is to be understood that both the foregoing general description and the following detailed description are exemplary and explanatory only and are not restrictive of the present disclosure or claims.

### BRIEF DESCRIPTION OF THE DRAWINGS

The drawings referenced herein are incorporated in and form part of the specification. The drawings illustrate one or more exemplary embodiments of the present disclosure and together with the description serve to explain various principles and operations. Implications that the drawings illustrate all embodiments of the invention are not to be made.

FIG. 1 illustrates a flow diagram showing registering a geo-differentiated virtual toll booth user.

FIG. 2 illustrates a flow diagram showing activating a registered user account with a toll provider.

FIG. 3 illustrates a flow diagram showing tracking a user vehicle.

FIG. 4 illustrates a flow diagram showing distributing toll fees.

FIG. 5 illustrates a flow diagram showing pre-paying toll fees.

FIG. 6 illustrates a schematic of user vehicle tracking with neighboring vehicles.

FIG. 7 illustrates a top view of user vehicle tracking with neighboring vehicles.

FIG. 8 illustrates a schematic of a geo-differentiated virtual toll booth system.

### DETAILED DESCRIPTION OF THE INVENTION

Reference will now be made in detail to various exemplary embodiments of the present disclosure, examples of which are illustrated in the accompanying drawings.

It will be readily understood that the components of the present invention, as generally described and illustrated in the figures herein, may be arranged and designed in a wide variety of different configurations. Thus, the following detailed description of the embodiments of the geo-differentiated virtual toll booth system and methods of the present invention, as presented in the figures, is not intended to limit the scope of the invention, as claimed, but is merely representative of selected embodiments of the invention.

Reference throughout this specification to “a select embodiment,” “one embodiment,” or “an embodiment” means that a particular feature, structure, or characteristic described in connection with the embodiment is included in at least one embodiment of the present invention. Thus, appearance of the phrases “a select embodiment,” “in one embodiment,” or “in an embodiment” in various places throughout this specification are not necessarily referring to the same embodiment.

Features, structure, or characteristics described herein may be combined in any suitable manner in one or more embodiments. One skilled in the relevant art will recognize, however, that the invention may be practiced without one or more of the specific details, or with other methods, components, or materials. In other instances, well-known materials or processes are not shown or described in detail to avoid obscuring aspects of the invention. The following description, which shows by way of illustration a specific embodiment in which the invention may be practiced, is intended only by way of example. That is, the following description simply illustrates certain selected embodiments of geo-differentiated virtual toll booth system and methods that are consistent with the invention as claimed herein. It is to be understood that other embodiments may be utilized because structural and process changes may be made without departing from the scope of the present invention.

In an exemplary embodiment, the geo-differentiated virtual toll booth (GDVTB) system and methods of the present invention may integrate toll operators at a national level for easy toll payments across tolling regions. The GDVTB of the present invention may leverage smart technology and its access to a global positioning system (GPS) to collect user vehicle location data. In an exemplary embodiment, a user vehicle may travel with a smart device, so a location of the smart device may approximate a location of the user vehicle. Using readily available vehicle identifier information, such as license tag numbers, the GDVTB may reconcile the collected smart device location data (user vehicle location data) with toll operator vehicle location data. For example, when a smart device location equates to a virtual toll collection zone owned by the toll operator, also referred to herein as toll provider, the reconciled location data may trigger payment of a toll associated with the virtual toll collection zone from a user account associated with the smart device to a toll operator system. The GDVTB vehicle identifier information may remain constant across toll operators, so a user may pay tolls seamlessly across multiple toll operations. Accordingly, multi-state travelers, such as commercial trucking fleets and out-of-state car renters, may no longer require multiple transponders to pay tolls across multiple toll operations.

In an exemplary embodiment of the present invention, to establish further positional accuracy of a user's smart device, and thus, a user's vehicle, the use of other positional technologies and communications protocols, such as Bluetooth, from nearby vehicles on the road may provide further positioning information and decrease error tolerances. In essence, there may be crowd sourcing of Bluetooth and other available positioning technologies from other vehicles on the road to receive multi frequency positioning to establish the best possible accuracy of a user vehicle location. Accordingly, the present invention may leverage available technologies and communications protocols to increase user vehicle location accuracy.

In another exemplary embodiment, the geo-differentiated virtual toll booth (GDVTB) system and methods of the present invention may integrate toll payments at a local level independently or with toll payments at a state or national level. For example, the GDVTB may enable micro-tolling, or a toll collection system at the local jurisdiction level. In an exemplary embodiment, the GDVTB may permit local jurisdictions to establish specific portions of a local highway or bridges for micro-tolling collection and payment. In an exemplary embodiment, micro-tolling may cover a metropolitan area or parking lot. In an embodiment, the GDVTB may accommodate micro-tolling for temporary events. For example, in an embodiment, a local government may collect tolls to mitigate costs of a festival, a busy weekend, or other temporary, local events. These tolls may provide additional revenue to the local government. The local government may provide a toll operator system, such as hardware or other elements described herein below, which may identify, for example, a temporary virtual toll collection zone. In an exemplary embodiment, the provided toll operator system may communicate with the GDVTB to accommodate specific tolling requirements. The flexibility provided by the GDVTB in accordance with the present invention may accommodate temporary tolling or event-based tolling, as well as local, regional, or national tolling in view of the description provided herein below. Accordingly, embodiments of the present invention, as described herein, support toll collection, including highway tolling and micro tolling.

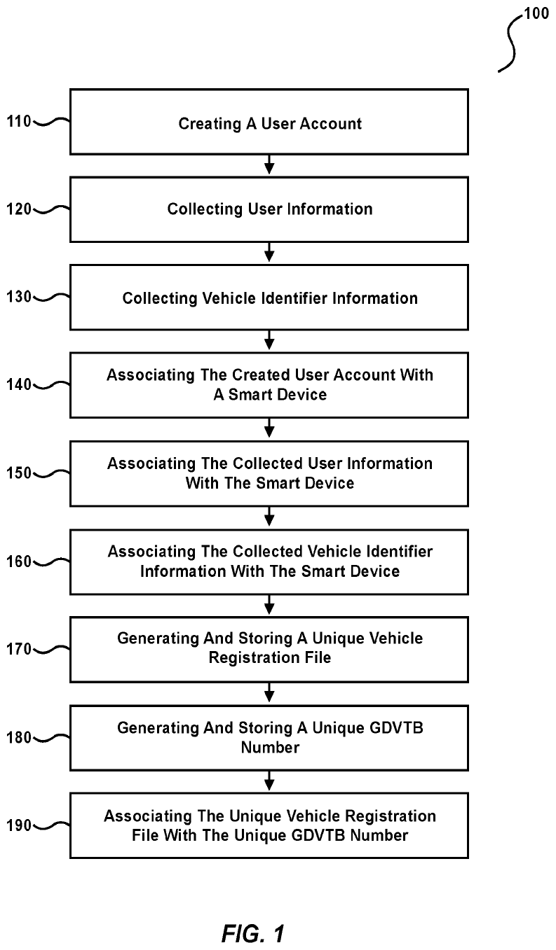

A geo-differentiated virtual toll both system in accordance with the present invention may require tracking a user vehicle, which may comprise registering a user and collecting vehicle location information associated with the registered user. FIG. 1 illustrates a flow diagram showing registering a geo-differentiated virtual toll booth (GDVTB) user (100) in accordance with the present invention. In an exemplary embodiment, the method of registering a GDVTB user (100) may initially comprise associating a user with a vehicle identifier. To do so, in an exemplary embodiment, registering a GDVTB user (100) may comprise creating a user account (110). In an exemplary embodiment, after creating a user account (110), registering a GDVTB user (100) may comprise populating the account with information. For example, registering a GDVTB user (100) may further comprise collecting user information (120). In an embodiment, for example, the user information may comprise, at least, user payment information, such as user credit card information. In an exemplary embodiment, registering a GDVTB user (100) may further comprise collecting vehicle identifier information (130), that is, basic information required for a toll provider to identify a vehicle crossing a toll. In an embodiment, for example, vehicle identifier information may comprise vehicle description information, for example, make, model, and year of vehicle and number of axles, and any combination thereof. The vehicle description information is presented for exemplary purposes and is not meant to be limiting. The vehicle identifier information may further comprise unique vehicle identifier information, such as license tag information or vehicle identification number (VIN). Other numbers uniquely identifying a vehicle may be contemplated within the present invention. Accordingly, the present invention may create a user account, which may comprise a user vehicle identifier.

As described herein above, the geo-differentiated virtual toll booth (GDVTB) system and methods of the present invention may leverage a user's smart device location to identify a user's vehicle location. In an embodiment, for example, registering a GDVTB user (100) may further comprise associating the created user account with a smart device (140). For example, in an embodiment, registering a GDVTB user (100) may comprise associating collected information with smart device's identifying information. For example, in an embodiment, registering a GDVTB user (100) may comprise associating the collected user information with the smart device (150). In an exemplary embodiment, registering a GDVTB user (100) may comprise associating the collected vehicle identifier information with the smart device (160). Accordingly, the present invention may collect user payment information and unique vehicle identifiers and may associate the collected information with a smart device.

In an exemplary embodiment, registering a GDVTB user (100) may further comprise generating and storing a unique vehicle registration file (170). In an embodiment, for example, registering a GDVTB user (100) may comprise generating a unique vehicle registration file with, for example, the created user account, collected user information, collected vehicle identifier information, associated smart device's identifying information, or any combination thereof. In an exemplary embodiment, registering a GDVTB user (100) may further comprise generating and storing a unique GDVTB number (180). In an exemplary embodiment, registering a GDVTB user (100) may further comprise associating the unique vehicle registration file with the unique GDVTB number with (190). Accordingly, the present invention may generate unique system identifiers for each created user account.

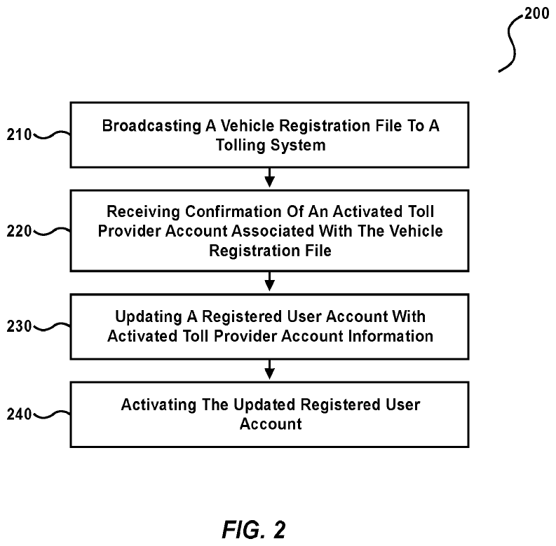

In an exemplary embodiment, the GDVTB may deploy a method for activating a registered user account with a toll provider. FIG. 2 illustrates a flow diagram showing activating a registered user account with a toll provider (200) in accordance with the present invention. As described in FIG. 1, the GDVTB may employ a method of registering a GDVTB user (100), which may comprise, at least, creating a user account (110) and associating a unique GDVTB number with a unique vehicle registration file (190) for the created user account. In an exemplary embodiment, activating a registered user account with a toll provider (200) may comprise broadcasting the associated unique GDVTB number, associated vehicle registration file, or any combination thereof, to toll providers and toll operator systems. In an exemplary embodiment, activating a registered user account with a toll provider (200) may comprise broadcasting a vehicle registration file to a tolling system (210). In an embodiment, for example, a tolling system may comprise at least one, some, or all toll providers and toll operator systems in a national tolling system or a collection of multiple regional tolling systems. At least one toll provider may receive the broadcast and may, for example, create a local toll provider account associated with the broadcasted vehicle registration file. The at least one toll provider may communicate these actions to the GDVTB system. In an exemplary embodiment, activating a registered user account with a toll provider (200) may further comprise receiving confirmation of an activated toll provider account associated with the vehicle registration file (220). In an exemplary embodiment, receiving confirmation of an activated toll provider account associated with the vehicle registration file (220) may comprise receiving confirmation from at least one, some, or all toll providers in a national tolling system. Accordingly, the present invention may communicate a vehicle registration file to a tolling system and receive confirmation of at least one toll provider's action on that communication.

In an embodiment, for example, an activated toll provider account may associate with a unique vehicle registration file or other GDVTB user-based identifier. In an exemplary embodiment, receiving confirmation of an activated toll provider account associated with the vehicle registration file (220) may comprise receiving, for example, a unique toll provider confirmation vehicle number. With that in mind, in an exemplary embodiment, activating a registered user account with a toll provider (200) may further comprise updating a registered user account with activated toll provider account information (230), which may comprise the unique toll provider confirmation vehicle number or other toll provider account information. In an exemplary embodiment, activating a registered user account with a toll provider (200) may further comprise activating the updated registered user account (240). In an embodiment, for example, activating a user account may comprise activating a vehicle location device, such as the associated smart device, as described in FIG. 1. Accordingly, the present invention may activate and associate toll provider systems with unique registered user accounts.

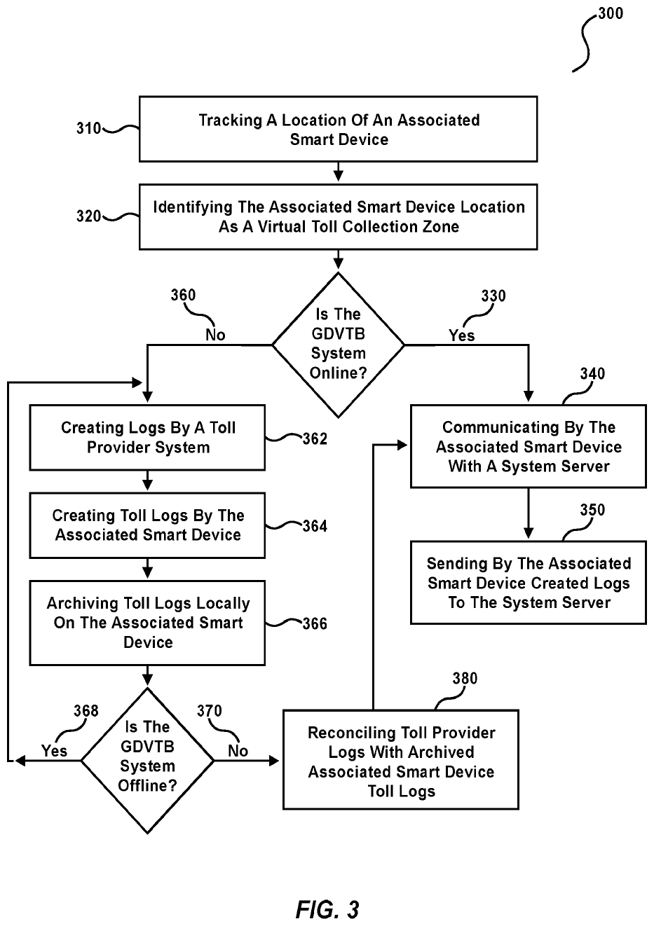

FIG. 3 illustrates a flow diagram showing tracking a user vehicle (300) in accordance with the present invention. As described herein above in FIG. 1, in an embodiment, registering a GDVTB user (100) may comprise associating the collected user information with the smart device (150). In an exemplary embodiment, registering a GDVTB user (100) may comprise associating the collected vehicle identifier information with the smart device (160). In an embodiment of the present invention, the method of tracking a user vehicle (300) may comprise leveraging the smart device's geo-location capabilities to identify a location of a vehicle associated with the unique vehicle identifier. In an embodiment, for example, a smart device, such as a smart phone, watch, tablet, or other form of smart device, alone or in combination, may track a location of a vehicle associated with the unique vehicle identifier. The list of smart devices provided herein is provided for exemplary purposes and is not meant to be limiting. The smart device may exist separately from the vehicle, such as a smart mobile device, a smart phone, or the smart device may exist embedded, or integrated within the vehicle. Accordingly, the present invention may leverage smart device technologies and their geo-tracking capabilities so a registered user may pay tolls to a toll operator.

In an embodiment, for example, tracking a user vehicle (300) may comprise identifying a location of an associated smart device as a user vehicle location. A method of tracking a user vehicle (300) may comprise tracking a location of an associated smart device (310). In an exemplary embodiment, tracking a location of the associated smart device (310) may comprise using the associated smart device for continuous location tracking, interval location tracking, sporadic location tracking, or combinations thereof. The location data may be transmitted utilizing the associated smart device's system of mobile data, such as 4G, GPRS, WiFi, or Bluetooth. Other data communication systems understood by persons of ordinary skill in the art are contemplated herein. In an exemplary embodiment, the method of tracking a user vehicle (300) may further comprise identifying the associated smart device location as a virtual toll collection zone (320) associated with toll fees and a toll operator system. In an embodiment of the present invention, a user associated with vehicle entering or crossing a virtual toll collection zone may be responsible for paying a toll associated with the virtual toll collection zone. Said differently, an associated smart device entering or crossing a virtual toll collection zone may trigger toll payment of a toll value by a registered user account associated with the smart device. A virtual toll collection zone may comprise, for example, a geographical area identified by a toll operator as a collection point for toll fees. In embodiments of the present invention, a virtual toll collection zone may comprise portions of single lanes or multiple lanes of national or local road systems identified for toll collection. In exemplary embodiments of the present invention, a virtual toll collection zone may comprise specific geographic zones such as metropolitan areas or parking lots. In an exemplary embodiment, a virtual toll collection zone may comprise micro-tolling location, such as temporary or event-based tolling locations. In an embodiment of the present invention, the virtual toll collection zones may comprise specific longitudinal and latitudinal coordinates or may comprise an area across longitudinal and latitudinal coordinates. Accordingly, tracking a user vehicle may comprise identifying a registered user's smart device as entering a virtual toll collection zone.

In an embodiment of the present invention, tracking a user vehicle (300) may comprise performing online and offline tasks. In an exemplary embodiment, a smart device communicates continuously, periodically, or at some frequency, with the system server. For example, in an embodiment, the smart device may periodically ping the system, which may identify the smart device as online. With that in mind, tracking a user vehicle (300) may comprise identifying a system as online (330). In an exemplary online embodiment, tracking a user vehicle (300) may further comprise communicating by the associated smart device with a system server (340), that is a GDVTB system server, and sending by the associated smart device created logs to the system server (350). In an exemplary embodiment, the associated smart device communicating with the system server (340) may comprise communicating that the associated smart device entered a virtual toll collection zone. In an embodiment, for example, a server may comprise a virtual server. Configured differently, in an embodiment, for example, a servicer may comprise a physical server. As described herein above, exemplary embodiments of the present invention may track a smart device location and may identify the location as a national, state, or local jurisdiction, as well as a micro-tolling virtual toll collection zone. Accordingly, the present invention may comprise notifying a system server that a registered user's associated smart device may be crossing or entering a virtual toll collection zone.

In an embodiment of the present invention, for example, a geo-differentiated virtual toll booth system may be unable to access the system server. For example, the server may be down, or the vehicle and smart device may be entering or traveling through a tunnel, dense forest, or other location without or with minimal Internet access. In that case, for example, the server may not have real-time acknowledgement of a smart device entering a virtual toll collection zone. In an embodiment, a geo-differentiated virtual tool booth system of the present invention may identify failure by the smart device to communicate, for example, continuously, periodically, or at some frequency, with the system server as an offline system. To that end, in an exemplary embodiment, tracking a user vehicle (300) may comprise identifying a system as offline (360). In an offline embodiment, for example, tracking a user vehicle (300) may further comprise creating logs by a toll provider system (362). In an embodiment, for example, later, these toll provider logs may be used to reconcile missed toll payments due to an offline system. In an exemplary embodiment, tracking a user vehicle (300) may further comprise creating toll logs by the associated smart device (364) and archiving toll logs locally on the associated smart device (366), for example, on a local driver. In an exemplary embodiment, at some interval, such as continuously or periodically, smart device location tracking technology may ping a GDVTB system on the associated smart device. In an embodiment, for example, tracking a user vehicle (300) may further comprise identifying the GDVTB system as remaining offline (368). In an alternative embodiment, for example, smart device location tracking technology may ping the GDVTB system on the associated smart device and identify the GDVTB system as active. In an embodiment, for example, tracking a user vehicle (300) may further comprise identifying the GDVTB system as online (370). In an exemplary embodiment, tracking a user vehicle (300) may further comprise reconciling toll provider logs with archived associated smart device toll logs (380). Accordingly, the present invention may maintain logs tracking a user vehicle while a system server is offline, and, once the system is online, the maintained logs may identify a smart device as having entered a virtual toll collection zone.

As described herein above in FIG. 3, a geo-differentiated virtual toll booth (GDVTB) of the present invention may receive associated smart device location information identifying a vehicle and associated smart device as entering or located in a virtual toll collection zone. In an exemplary embodiment, smart device technology may communicate the “inside toll position” location to a GDVTB server of the present invention. In an exemplary embodiment, the GDVTB server of the present invention may request location confirmation from an alternative location technology in communication with the associated smart device. For example, as described herein below in FIGS. A GDVTB of the present invention may leverage Bluetooth communications with neighboring vehicles to “crowdsource” and increase accuracy of a user vehicle's location. Accordingly, a GDVTB of the present invention may receive and double check location tracking of a registered user's vehicle and associated smart device.

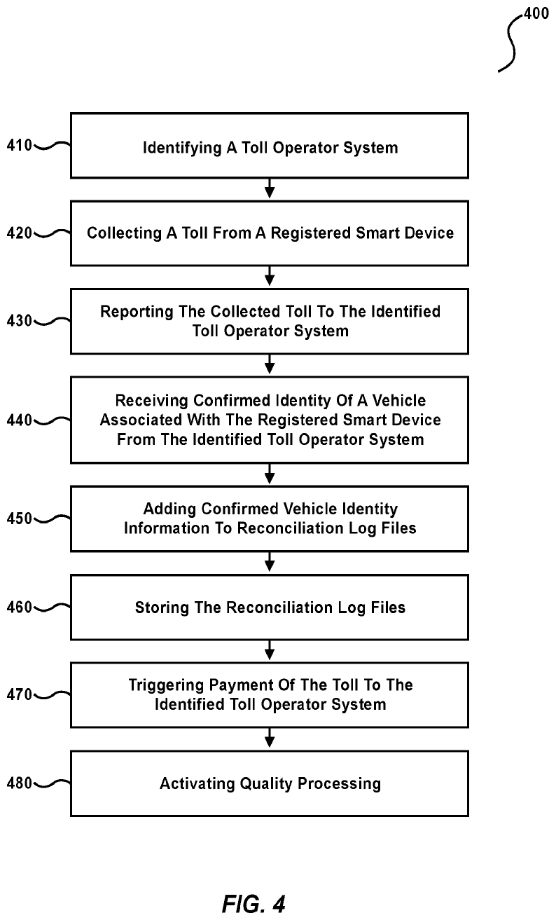

A GDVTB may collect toll fees from a registered user and distribute the toll fees to an appropriate toll operator. FIG. 4 illustrates a flow diagram showing distributing toll fees (400) to an owner of a virtual toll collection zone, such as a toll operator, in accordance with the present invention. In an exemplary embodiment, a registered user's smart device entering or crossing a virtual toll collection zone may trigger payment of a toll to a toll operator system. In an exemplary embodiment of the present invention, distributing toll fees (400) may comprise identifying a toll operator system (410) and collecting a toll from a registered smart device (420), that is, a registered user's associated smart device. As described in FIGS. 1 and 2, generally, a registered user account may associate with a smart device and may be updated with activated toll provider account information. In an exemplary embodiment, distributing toll fees may further comprise reporting the collected toll to the identified toll operator system (430). In an embodiment, for example, a GDVTB of the present invention may create a unique vehicle pay toll file based on, for example, a toll number, toll provider, day, time, and associated vehicle identifier information, as described in FIG. 1. In this respect, for example, in an embodiment, reporting the collected toll to the identified toll operator (430) may comprise a GDVTB server of the present invention communicating a unique vehicle pay toll file to an identified toll operator system. Accordingly, the present invention may begin a process of collecting tolls from a registered user prior to confirming that a toll operator expects payment.

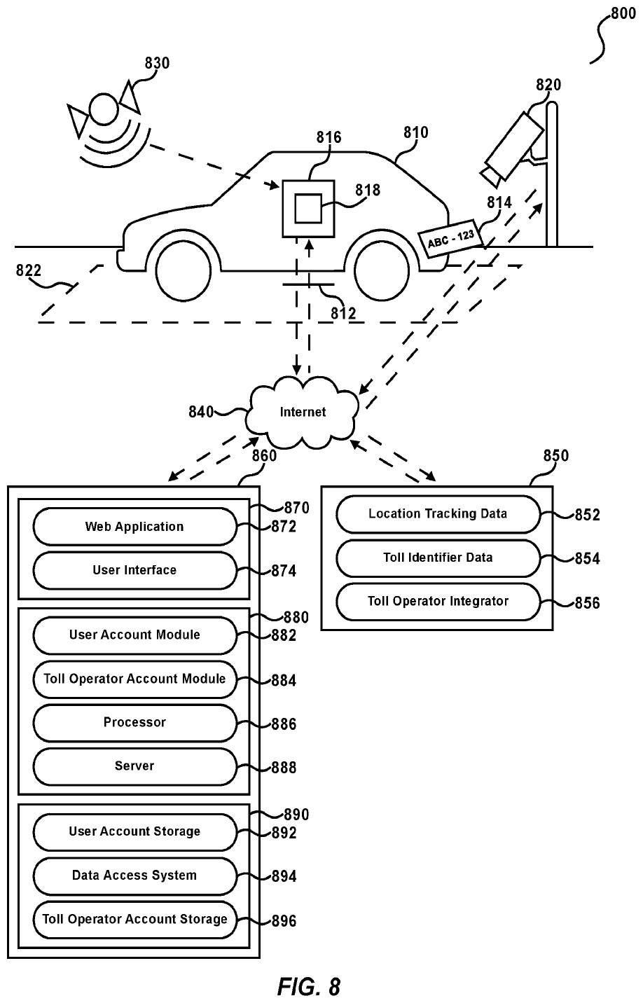

In an exemplary embodiment of the present invention, distributing toll fees (400) may further comprise receiving confirmed identity of a vehicle associated with the registered smart device from the identified toll operator system (440) at the virtual toll collection zone. In an exemplary embodiment, a toll operator may confirm a location of a vehicle using a vehicle identifier, such as, but not limited to, a license tag. As described herein above with respect to FIG. 1, in an exemplary embodiment, a registered user account, and, thus, a vehicle, may be associated with both a smart device and a vehicle identifier. As described in FIG. 2, a toll provider may confirm activating a toll provider account associated with a registered users vehicle registration file (220). As described below in FIG. 8, the identified toll operator system may capture identity of a vehicle associated with a smart device, which is associated with a registered user, using a toll operator capture system (820). Specifically, in an exemplary embodiment, the toll operator system may use a captured identity of a vehicle moving into a virtual toll collection zone to confirm the moving vehicle as a vehicle associated with the registered smart device. In an exemplary embodiment, distributing toll fees (400) may further comprise adding confirmed vehicle identity information to reconciliation log files (450) and storing the reconciliation logs (460) in a GDVTB system database. In an exemplary embodiment, the GDVTB system may reconcile vehicle identity and payments with toll operator systems for each toll passed for each toll operator. Accordingly, the present invention may receive confirmation of a registered user's vehicle in a virtual toll collection zone and maintain reconciliation logs for future reconciliation.

As described herein above, an exemplary embodiment of distributing toll fees (400) may comprise receiving confirmed identity of a vehicle associated with the registered smart device from the identified toll operator system (440) at the virtual toll collection zone, adding confirmed vehicle information to reconciliation log files (450) and storing the reconciliation logs (460) in a GDVTB system database. Reconciliation may comprise, for example, a GDVTB system server creating a unique reconciliation log file at a periodic frequency, such as daily, communicated with a toll operator system for each toll provider. In an embodiment, for example, for each transaction a toll operator system or toll provider confirms, the GDVTB system server may update reconciliation logs in the GDVTB system database. The GDVTB system may prohibit, or identify an error if, two files exist for the same transaction. In an embodiment, when a new reconciliation database file is created, the GDVTB system server may close and archive old reconciliation log files in the GDVTB system database. In an exemplary embodiment, the GDVTB system may communicate the archived reconciliation log files to the appropriate toll operator system. Accordingly, the present invention may reconcile toll logs before communicating potential toll payments with a toll provider.

In an embodiment, for example, the GDVTB system may receive confirmation, such as a unique confirmation file, from the toll provider with all accepted transactions. Alternatively, in an embodiment, the GDVTB system may receive “concern” files from the toll provider with disputed transactions on a communicated archived reconciliation log file for, for example, a given day or other period of time. In an exemplary embodiment, the GDVTB may communicate receipt of the unique confirmation files and concern files to the sending toll provider. In view of the reconciled log file confirmations, the GDVTB may prepare toll payment processing for the confirmations. Alternatively, the GDVTB of the present invention may prepare reports for future reconciliation of concern files with the toll provider. Accordingly, the present invention may receive confirmation from a toll provider before trigging payment to the toll operator.

In an embodiment, for example, once a toll operator confirms, using a vehicle identifier, that a vehicle entered or crossed a virtual toll collection zone, distributing toll fees (400) may further comprise triggering payment of the toll to the identified toll operator system (470) from a registered user account associated with the vehicle identifier. In an embodiment, for example, a toll may comprise a toll value, which a toll operating system may establish fixed or variable. In an exemplary embodiment of the present invention, registered users may receive confirmation data from toll operators regarding individual toll payments. In an embodiment of the present invention, a GDVTB database and server, as described herein below, may communicate payment information safely, securely, and quickly. For example, in an embodiment, all payment data may be encrypted. Accordingly, the present invention may trigger payment of toll fees from a registered user account.

As described herein above, distributing toll fees (400) may comprise triggering toll collection from a registered user's account, and may include distributing collected toll payments to an identified toll operator. Also as described above, toll operators may comprise national, state, or local jurisdictions. An exemplary embodiment of the present invention may support integration of all toll operators and toll collection systems, so the registered user may experience seamless toll payment, regardless of who owns the virtual toll collection zone. Accordingly, the present invention may collect tolls from a registered user's account and distribute the collected tolls to a toll operator.

As described herein above, and in view of FIGS. 1-4, a method of collecting toll payments may comprise associating a smart device with a user account, as described in FIG. 1, and tracking a location of the associated smart device, as described in FIG. 3. A method of collecting toll payment may further comprise identifying the associated first smart device location as a virtual toll collection zone, as described in FIG. 3. In an embodiment, the virtual toll collection zone may be associated with toll fees and a toll operator system. A method of collecting toll payments may further comprise distributing the toll fees from the user account to the toll operator system, as described herein above in FIG. 4. Accordingly, the present invention may track a user vehicle and collect toll payments.

In an alternative embodiment of the present invention, a toll operator may be unable to confirm that a vehicle associated with a vehicle identifier and a smart device entered or crossed a virtual toll collection zone. In this case, for example, distributing toll fees (400) may comprise activating quality processing (480). Quality processing may comprise, for example, identifying errors in global positioning, vehicle identifier, or toll operator location data, or combinations thereof. Accordingly, the present invention may comprise mechanisms for quality control and increased customer service.

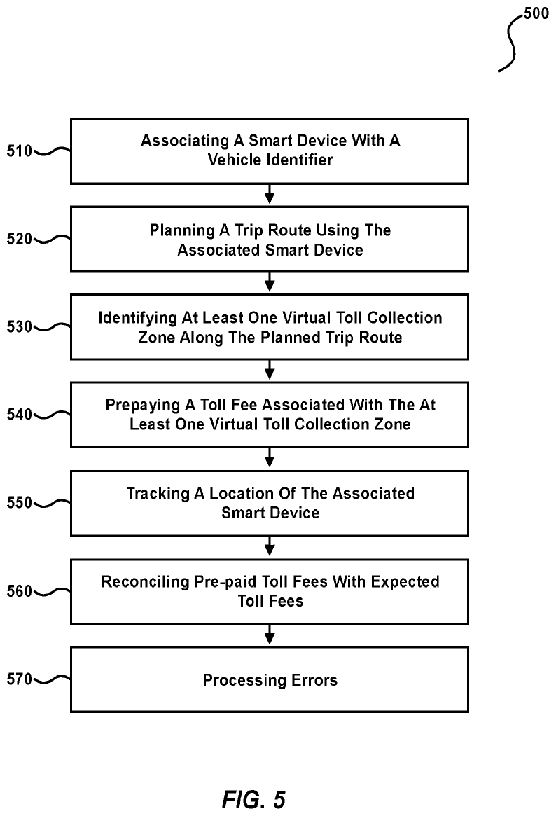

In an embodiment of the present invention, a registered user may plan a trip route and may pre-pay tolls associated with virtual collection toll zones along the trip route. FIG. 5 illustrates a flow diagram showing pre-paying toll fees (500) in accordance with the present invention. As described herein above with respect to FIG. 1, a method of pre-paying toll fees (500) may initially comprise registering a user and collecting vehicle location information associated with the registered user. In an exemplary embodiment, the method of pre-paying toll fees (500) may initially comprise associating a user with a vehicle identifier. To do so, in an exemplary embodiment, method of pre-paying toll fees (500) may comprise creating a user account associated with a smart device; the user account may comprise user payment information and user vehicle information. The vehicle information may comprise vehicle description information, for example, make, model, and year of vehicle and number of axles, and any combination thereof. The description information is presented for exemplary purposes and is not meant to be limiting. The vehicle information may further comprise unique vehicle identifier information, such as license tag numbers or vehicle identification number (VIN). Other numbers uniquely identifying a vehicle may be contemplated within the present invention. To that end, a method of pre-paying toll fees (500) may comprise associating a smart device with a vehicle identifier (510). Accordingly, the present invention may associate user payment information and a unique vehicle identifier with a smart device.

In an exemplary embodiment, a method of pre-paying toll fees (500) may further comprise planning a trip route using the associated smart device (520) and identifying at least one virtual toll collection zone along the planned trip route (530). In an embodiment, for example, a method of pre-paying toll fees may further comprise pre-paying, with the registered user account, a toll fee associated with the at least one virtual toll collection zone (540). In an embodiment of the present invention, a method of pre-paying toll fees (500) may further comprise tracking a location of the associated smart device (550) along the planned trip route and reconciling pre-paid toll fees with expected toll fees (560) of crossed virtual toll collection zones. In an embodiment of the present invention, the pre-paid toll fees may not reconcile with the expected toll fees. To that end, an embodiment of the present invention may, for example, comprise quality processing, or processing errors (570). The quality processing may comprise quality checks within the system or between the system of the present invention and toll operators' systems along the planned trip route. Accordingly, the present invention may support pre-payment of tolls for virtual toll collection zones along a planned trip route.

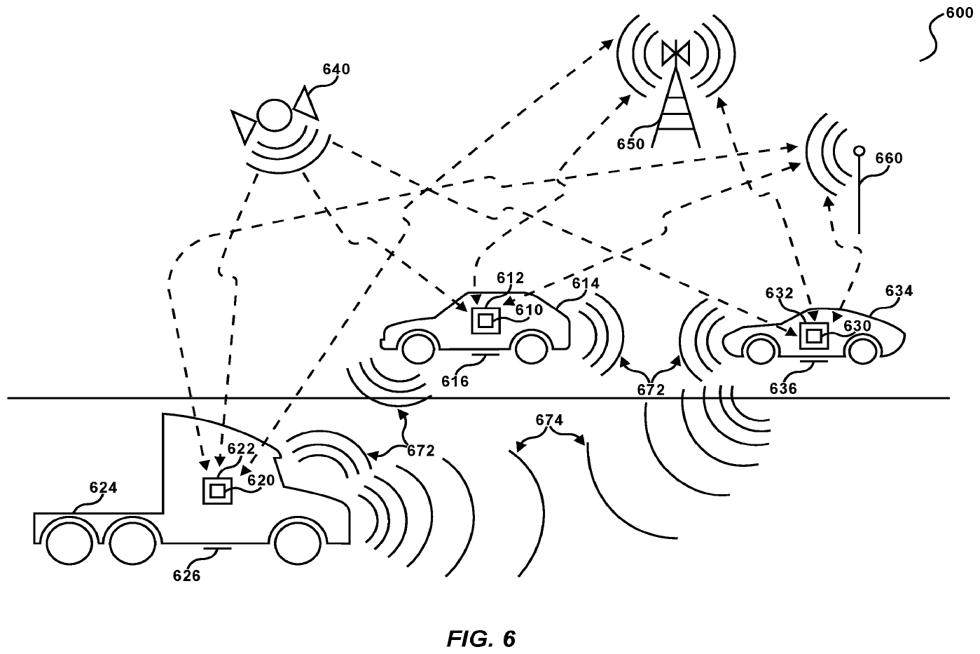

As described above, in an exemplary embodiment of the present invention, to establish further positional accuracy, the use of other positional technologies such as Bluetooth, from nearby vehicles on the road may provide further positioning information and decrease error tolerances. In an exemplary embodiment, the present invention may enable crowd sourcing of Bluetooth and other available positioning technologies from other vehicles on the road to receive multi frequency positioning to establish the best possible accuracy. FIG. 6 illustrates a schematic of user vehicle tracking with neighboring vehicles (600) in accordance with the present invention. In an exemplary embodiment, a first GDVTB system (610) may be associated with a first associated smart device (612) on a first vehicle (614); second GDVTB system (620) may be associated with a second associated smart device (622) on a second vehicle (624); and a third GDVTB system (630) may be associated with a third associated smart device (632) and a third vehicle (634). In an embodiment, user vehicle tracking with neighboring vehicles (600) may comprise, for example, a combination of location system and network communications. For example, in an embodiment, a combination of a global positioning system (640), cell tower communications (650), and wi-fi Internet connections (660), may communicate with the first GDTVB system (610), second GDVTB system (620), and third GDVTB system (630), or any combination thereof. In an exemplary embodiment of user vehicle tracking with neighboring vehicles (600), a GDVTB system may calculate a position of a vehicle based on global positioning system (640), cellular towers (650) and public wi-fi networks (660). Accordingly, the present invention may leverage available technologies to improve accuracy of a registered user's vehicle's position.

In an embodiment, for example, a GDVTB system associated with a first registered user may continuously, frequently, or periodically listen via, for example, Bluetooth technology, for neighboring GDVTB systems associated with, for example, a second registered user, a third registered user, or more. With this in mind, in an exemplary embodiment, user vehicle tracking with neighboring vehicles (600) may further comprise Bluetooth communications, (672), (674), (676), between the first associated smart device (612) and the second associated smart device (622), the second associated smart device (622) and third associated smart device (624), and the first associated smart device (612) and third associated smart device (624), respectively. The number of devices is provided for exemplary purposes. Accordingly, using available satellite-based navigation and communication networks, multiple associated smart devices may communicate vehicle location by Bluetooth.

As described in FIG. 3, in an exemplary embodiment, tracking a user vehicle (300) may comprise identifying a location of an associated smart device as a user vehicle location. In an exemplary embodiment of the present invention, tracking a user vehicle may further comprise leveraging locations of nearby vehicles. In an exemplary embodiment, a first GDVTB system (610) may identify a second GDVTB system (620) or a third GDVTB system (630) via Bluetooth communications, (672) and (674), respectively. In an embodiment of user vehicle tracking with neighboring vehicles (600), for example, the first GDVTB system (610) may communicate a first location (616) of a first associated smart device (612) to the second GDVTB system (620). Similarly, in an embodiment, for example, the second GDVTB system (620) may communicate a second location (626) of a second associated smart device (622) to the first GDVTB system (610). Similarly, via Bluetooth communications, (674) and (676) respectively, a third GDVTB system (630) may communicate a third location (636) of a third associated smart device (632) to a first GDVTB system (610) and a second GDVTB system (620). In an exemplary embodiment of user vehicle tracking with neighboring vehicles (600), the first GDVTB system (610), the second GDVTB system (620), and the third GDVTB system (630) may compare and recalculate a first location (616), second location (626), and a third location (636), in view of a combination of a first location (616), second location (626), and third location (636). In an embodiment, for example, the first GDVTB system (610), may update the first location (616) of the associated first smart device (612), the second GDVTB system (620) may update the second location (626) of the associated second smart device (622), and the third GDVTB system (630) may update the third location (636) of the associated third smart device (632) based on the recalculated locations. Accordingly, the present invention may use neighboring car locations and Bluetooth technologies to improve accuracy of a registered user's vehicle's location.

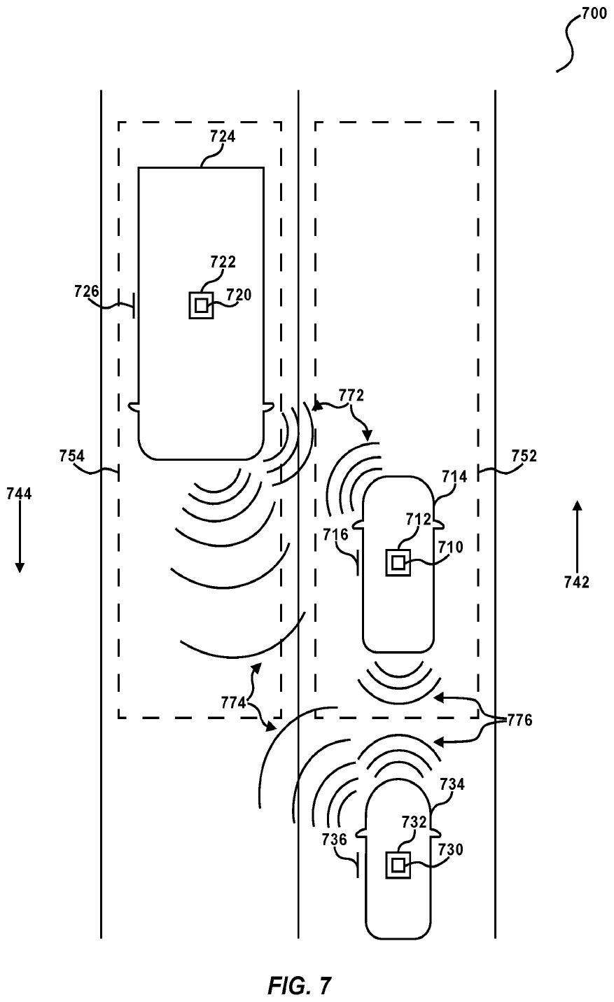

FIG. 7 illustrates a top view of user vehicle tracking with neighboring vehicles (700) in accordance with the present invention. In an exemplary embodiment, a first GDVTB system (710) may be associated with a first associated smart device (712) on a first vehicle (714); a second GDVTB system (720) may be associated with a second associated smart device (722) on a second vehicle (724); and a third GDVTB system (730) may be associated with a third associated smart device (732) and a third vehicle (734). In an exemplary embodiment of user vehicle tracking with neighboring vehicles (700), a GDVTB system may calculate a position of each user vehicle based on global positioning system, cellular towers and public wi-fi networks. Accordingly, the present invention may leverage available technologies to improve accuracy of a registered user's vehicle's position.

In an embodiment, for example, a GDVTB system associated with a first registered user may continuously, frequently, or periodically listen via, for example, Bluetooth technology, for neighboring GDVTB systems associated with, for example, a second registered user, a third registered user, or more. With this in mind, in an exemplary embodiment, user vehicle tracking with neighboring vehicles (700) may further comprise Bluetooth communications (772), (774), (776), between the first associated smart device (712) and the second associated smart device (722), the second associated smart device (722) and third associated smart device (724), and the first associated smart device (712) and third associated smart device (724), respectively. The number of devices is provided for exemplary purposes. In an exemplary embodiment, a first GDVTB system (710) may identify a second GDVTB system (720) or a third GDVTB system (730) via Bluetooth communications (772) and (776), respectively. In an exemplary embodiment, a second GDVTB system (720) may identify a first GDVTB system (710) or a third GDVTB system (730) via Bluetooth communications (772) and (774), respectively. In an exemplary embodiment, a third GDVTB system (730) may identify a first GDVTB system (710) or a second GDVTB system (720) via Bluetooth communications (776) and (774), respectively. Accordingly, the present invention may use available communication networks, so multiple associated smart devices may communicate by Bluetooth.

In an embodiment of user vehicle tracking with neighboring vehicles (700), for example, the first GDVTB system (710) may communicate a first location (716) of a first associated smart device (712) to the second GDVTB system (720) or the third GDVTB system (730). In an exemplary embodiment, the first location (716) may comprise a first virtual toll collection zone (752). Similarly, in an embodiment, for example, the second GDVTB system (720) may communicate a second location (726) of a second associated smart device (722) to the first GDVTB system (710) or the third GDVTB system (730). In an exemplary embodiment, the second location (726) may comprise a second virtual toll collection zone (754). Similarly, via Bluetooth communications, a third GDVTB system (730) may communicate a third location (736) of a third associated smart device (732) to a first GDVTB system (710) or a second GDVTB system (720). In an exemplary embodiment, the third location (736) may not be a virtual toll collection zone. In an exemplary embodiment of user vehicle tracking with neighboring vehicles (700), the first GDVTB system (710), the second GDVTB system (720), and the third GDVTB system (730) may compare a first location (716), second location (726), and a third location (736). In an embodiment, for example, of user vehicle tracking with neighboring vehicles (700), the first GDVTB system (710), the second GDVTB system (720), and the third GDVTB system (730) may recalculate, update, and increase accuracy in a first location (716), second location (726), and a third location (736), in view of a combination of a first location (716), second location (726), and third location (736). Accordingly, the present invention may use neighboring car locations and Bluetooth technologies to improve accuracy of a registered user's vehicle's location.

In an exemplary embodiment, a virtual toll collection zone may comprise one zone across two road directions. In an alternative embodiment, as shown in FIG. 7, a virtual toll collection zone may comprise separate virtual toll collection zones for separate sides of a road. For example, the first vehicle (714) and the third vehicle (734) may travel a first direction (742) and may cross a first virtual toll zone (752). In an embodiment, for example, the second vehicle (724) may travel a second direction (744) and may cross a second virtual toll zone (754). Accordingly, the present invention may use neighboring car locations travelling in same or opposite directions to improve accuracy of a registered user's vehicle's location.

As described herein above, a geo-differentiated virtual toll booth (GDVTB) of the present invention may rely on smart technology and toll operator data collection. An embodiment of the present invention may further leverage network communications between smart technology and database management systems. FIG. 8 illustrates a schematic of a geo-differentiated virtual toll booth (GDVTB) system (800) in accordance with the present disclosure. In an exemplary embodiment, the system may comprise a smart device positioned with a vehicle. As described herein above with respect to FIG. 1, a user of the geo-differentiated virtual toll booth may create a registered user account, that is register a user and an associated smart device. The registration process may comprise, at least, associating a created user account with a vehicle (810), a vehicle identifier (814), and a smart device (816) associated with the GDVTB system (818). As described herein above with respect to FIG. 1, the vehicle identifier (814) may comprise, but is not limited to, a license tag, a vehicle identification number (VIN), or combinations thereof. The smart device (816) may comprise smart technology embedded as part of the vehicle (810), in communication with the vehicle (810), or separate from the vehicle (810), such as a smart phone or mobile smart device. Accordingly, the present invention may position smart technology with a vehicle.

In an exemplary embodiment, the vehicle (810) may associate with a smart device (816), such as a smart phone. In an embodiment, for example, the smart device (816) may communicate information regarding vehicle location (812), which is a location of an associated smart device (816) to a GDVTB server (886), described herein below. The geo-differentiated virtual toll booth system (800) may further comprise a toll operator capture system (820) and a global positioning system (830). In an exemplary embodiment of the present invention, the smart device (818) may collect information from the global positioning system (830) and may use the collected information to reconcile the smart device or vehicle location (812). In an exemplary embodiment, the collected information may be used to identify a location of the smart device (816) associated with the vehicle (810). In an exemplary embodiment, vehicle location (812) information may comprise, for example, identification of a virtual toll collection zone (822) associated with a toll operating system and a toll value. As described herein above in FIGS. 3, 6, and 7, a GDVTB system associated with a registered user's associated smart device, alone or in combination with neighboring GDVTB systems may geo-locate a registered user's vehicle location (812). Accordingly, the present invention may identify a location of a smart device associated with a registered user.

The smart device (816) and the toll operator capture system (820) may collect and communicate a location of the vehicle (812), via a location of the smart device (816), and a location of a vehicle identifier (814), respectively. This location information, as described above, may be associated with a registered user, and may be communicated via a communication network (840), such as the Internet, to a toll operator system (850), and a registered user system (860). In an exemplary embodiment, the location information collected from different sources may be reconciled to trigger a registered user's payment of a toll owned by the toll operator system (850). Accordingly, the present invention may communicate and capture registered user data and toll operator data.

In an exemplary embodiment, the geo-differentiated virtual toll booth system (800) may further comprise means for charging and collecting funds from a registered user for crossed or entered virtual toll collection zones (822), as described with respect to FIG. 1. To do so, in an exemplary embodiment, a toll operator system (850) may communicate via a communications network (840) with a registered user system (860). In an embodiment, for example, the toll operator system (850) may comprise location tracking data (852), toll identifier data (854), and a toll operator integrator (856). In an exemplary embodiment, a geo-differentiated virtual toll booth system (800) of the present invention may activate communication and integration between the toll operator system (850) and the registered user system (860) via the toll operator integrator (856) and the communications network (840). In an exemplary embodiment, the toll operator integrator (856) may, for example, communicate virtual toll collection zone (822) location and fees to the registered user system (860). For example, as described in FIG. 2, the toll operator integrator (856) may communicate confirmation of an activated toll provider account associated with a vehicle registration file. In an exemplary embodiment, as described in FIG. 3, the toll operator integrator (856) may communicate toll logs for reconciliation. Accordingly, virtual toll collection zone data may be communicated via a toll operator integrator to a registered user system.

In an exemplary embodiment, the registered user system (860) of a geo-differentiated virtual toll booth system (800) may communicate via the communications network (840) with, for example, a GDVTB system (818) associated with a smart device (816), a toll operator integrator (856), or another user interface. In an embodiment, for example, the registered user system (860) may receive, store, and process information, such as information described in FIGS. 1, 2, 3, 4, and 5. For example, processing may comprise registering a geo-differentiated virtual toll booth user, activating a registered user account with a toll provider, tracking user vehicle location, reconciling offline location logs, or paying tolls. In an embodiment of the present invention, the registered user system (860) may comprise a user system (870), processing system (880), and database management system (890). For example, in an embodiment, the user system (870) may communicate with the processing system (880), which may communicate with the database management system (890). Accordingly, the present invention may collect, process, and store information relevant for user toll payments.

In an embodiment, the user system (870) may collect and communicate information and may comprise a web application (872), and a user interface (874). In an embodiment, for example, the processing system (880) may process collected information and may comprise a user accounts module (882), a toll operators accounts module (884), a processor (886), and a server (888). In an embodiment, for example, a processing system (880) of the present invention may comprise virtual servers and associated processors. In an embodiment, the database management system (890) may store collected and processed information, and may comprise, for example, user accounts storage (892) and toll operator accounts storage (896). In an exemplary embodiment, the database management system may further comprise a data access system (894). As described above, in an exemplary embodiment, the processor may enable toll value payments, log reconciliations, and other data manipulations or transactions. Accordingly, the present invention may comprise tools for communicating virtual toll collection zone fees and user account payments between a toll operator system and a registered user system.

It is to be understood that the various embodiments shown and described herein are to be taken as exemplary. Elements and materials, and arrangements of those elements and materials, may be substituted for those illustrated and described herein, parts may be reversed, and certain features of the present disclosure may be utilized independently, as would be apparent to one skilled in the art after having the benefit of the description herein. Changes may be made in the elements described herein without departing from the spirit and scope of the present disclosure and following claims, including their equivalents.

It is to be understood that the particular embodiments set forth herein are non-limiting, and modifications to structure, dimensions, materials, and methodologies may be made without departing from the scope of the present disclosure.

It is to be further understood that this description's terminology is not intended to limit the invention. For example, spatially relative terms, such as “front,” “back,” “top,” “bottom,” “side,” and the like, may be used to describe one element's or feature's relationship to another element or feature as intended to connote the orientation of, for example, the geo-differentiated virtual toll booth as illustrated in the figures.

For the purposes of this specification and appended claims, unless otherwise indicated, all numbers expressing quantities, percentages or proportions, and other numerical values used in the specification and claims, are to be understood as being modified in all instance by the term “about” if they are not already. That is, unless indicated to the contrary, the numerical parameters set forth in the specification and claims are approximations that may vary depending on the desired properties sought to be obtained by the present disclosure.

What is claimed is:

1. A toll collection system, comprising:
a smart device associated with a registered user account;
the associated smart device and a toll operating system in communication via a geo-differentiated virtual toll booth;
a virtual toll collection zone associated with the toll operating system and a toll value and communicated to the associated smart device;
the toll value paid by the registered user account to the toll operating system via the geo-differentiated virtual toll booth.

2. The toll collection system of claim 1, wherein the smart device is selected from the group consisting of a mobile device, a smart phone, smart technology embedded in a vehicle, and combinations thereof.

3. The toll collection system of claim 1, further comprising the communicated virtual toll collection zone associated with a longitudinal location and a latitudinal location.

4. The toll collection system of claim 1, wherein the communicated virtual toll collection zone further comprises a portion of an area selected from the group consisting of a single lane, multiple lanes, parking lots, and combinations thereof

5. The toll collection system of claim 1, further comprising the virtual toll collection zone operated as a micro tolling zone.

6. The toll collection system of claim 1, wherein the vehicle identifier comprises vehicular information selected from the group consisting of license tag, number of axels, class, weight, and combinations thereof.

7. A method of collecting toll payments, the method comprising:
associating a first smart device with a first user account;
tracking a location of the associated first smart device;
identifying the associated first smart device location as a virtual toll collection zone associated with toll fees and a toll operator system; and
distributing the toll fees from the first user account to the toll operator system.

8. The method of claim 7, wherein the associated first smart device is selected from the group consisting of a mobile device, a smart phone, smart technology embedded in a vehicle, and combinations thereof.

9. The method of claim 7, wherein the associated first smart device location further comprises a portion of an area selected from the group consisting of a single lane, multiple lanes, parking lots, and combinations thereof.

10. The method of claim 9, further comprising identifying the virtual toll collection zone as a micro tolling zone.

11. The method of claim 7, further comprising associating the user account with vehicle identifier information selected from the group consisting of license tag, number of axels, class, weight, and combinations thereof.

12. The method of claim 7, further comprising
tracking a location of at least a second smart device associated with a second user account;
communicating via Bluetooth the location of the associated at least second smart device to the associated first smart device;
comparing the location of the associated at least second smart device to the location of the associated first smart device; and
updating the location of the associated first smart device.

13. A method of pre-collecting toll payments, the method comprising:
associating a smart device with a vehicle identifier;
planning a trip route using the associated smart device;
identifying at least one virtual toll collection zone along the trip route;
pre-paying a toll fee associated with the at least one virtual toll collection zone;
tracking a location of the smart device; and
processing errors in toll fee pre-payments.
